(19) United States
(12) Patent Application Publication
(10) Pub. No.: US 2025/0024291 A1
(43) Pub. Date: Jan. 16, 2025

(54) METHOD AND DEVICE FOR PROCESSING MULTIPLE QUALITY-OF-SERVICE FOR POSITIONING

(71) Applicant: Samsung Electronics Co., Ltd., Suwon-si, Gyeonggi-do (KR)

(72) Inventors: June HWANG, Suwon-si (KR); David Gutierrez ESTEVEZ, Staines (GB); Mythri HUNUKUMBURE, Staines (GB)

(21) Appl. No.: 18/577,451

(22) PCT Filed: Jul. 20, 2022
(86) PCT No.: PCT/KR2022/010592

§ 371 Date: Jan. 8, 2024

(30) Foreign Application Priority Data
Jul. 20, 2021 (KR) 10-2021-0095132

(51) Int. Cl. H04W 24/10; H04W 64/00

(52) U.S. Cl. CPC H04W 24/10; H04W 64/00

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. In the present invention, a location-based server delivers, to a terminal, multiple quality-of-service factors by using a certain message, and the terminal performs measurement according to a specific priority and determines whether a given quality-of-service factor is satisfied.

### TECHNICAL FIELD

The disclosure relates to a method for implementing services for finding a location of a terminal. Among them, the disclosure relates to a method for processing multiple quality-of-service settings.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed. The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

As described above, since various services can be provided in accordance with the development of a wireless communication system, there is a need for schemes for effectively providing such services.

### DISCLOSURE OF INVENTION

### Technical Problem

In case of directing sequential quality instructions to a terminal as an operation after receiving multiple quality-of-service instructions from a location services (LCS) client of a location management function (LMF), it causes the occurrence of a delay time and a problem to services, and thus a method for solving this is required.

### Solution to Problem

A terminal in a wireless communication system according to an embodiment of the disclosure may include: a transceiver; and a controller configured to control the transceiver to: receive, from a location management function (LMF) entity, a first message including a plurality of accuracy values corresponding to a plurality of quality of service (QOS) levels, for requesting measurement of signals for positioning, and transmit, to the LMF entity, a second message including a measurement result corresponding to a certain accuracy value among the plurality of accuracy values and an indicator for the certain accuracy value corresponding to the measurement result.

A location management function (LMF) entity in a wireless communication system according to another embodiment of the disclosure may include: a transceiver; and a controller configured to control the transceiver to: transmit, to a terminal, a first message including a plurality of accuracy values corresponding to a plurality of quality of service (QOS) levels, for requesting measurement of signals for positioning, receive, from the terminal, a second message including a measurement result corresponding to a certain accuracy value among the plurality of accuracy values and an indicator for the certain accuracy value corresponding to the measurement result, and transmit, to a location services (LCS) client having requested a service for the positioning, a third message including the measurement result and the indicator for the certain accuracy value based on the received second message. A control method of a terminal in a wireless communication system according to an embodiment of the disclosure may include: receiving, from a location management function (LMF) entity, a first message including a plurality of accuracy values corresponding to a plurality of quality of service (QOS) levels, for requesting measurement of signals for positioning; and transmitting, to the LMF entity, a second message including a measurement result corresponding to a certain accuracy value among the plurality of accuracy values and an indicator for the certain accuracy value corresponding to the measurement result.

A control method of a location management function (LMF) entity in a wireless communication system according to another embodiment of the disclosure may include: transmitting, to a terminal, a first message including a plurality of accuracy values corresponding to a plurality of quality of service (QOS) levels, for requesting measurement of signals for positioning; receiving, from the terminal, a second message including a measurement result corresponding to a certain accuracy value among the plurality of accuracy values and an indicator for the certain accuracy value corresponding to the measurement result; and transmitting, to a location services (LCS) client having requested a service for the positioning, a third message including the measurement result and the indicator for the certain accuracy value based on the received second message, wherein the plurality of accuracy values include a first value and a second value, and the QoS level of the first value is higher than the QoS level of the second value.

### Advantageous Effects of Invention

According to an embodiment of the disclosure, if multiple quality-of-service factors are configured and received from the LMF, the terminal can perform measurement and determination of whether the respective quality-of-service factors are satisfied, and in case of failure, the terminal can perform determination of whether a next quality-of-service factor is satisfied. In the above process, an additional signal with the LMF is not required.

### BRIEF DESCRIPTION OF DRAWINGS

FIG. 1 illustrates a diagram illustrating the structure of an LTE system according to an embodiment of the disclosure.

FIG. 2 illustrates a diagram illustrating a radio protocol structure in an LTE system according to an embodiment of the disclosure.

FIG. 3 illustrates a diagram illustrating the structure of a next generation mobile communication system according to an embodiment of the disclosure.

FIG. 4 illustrates a diagram illustrating a radio protocol structure of a next generation mobile communication system according to an embodiment of the disclosure.

FIG. 5 illustrates a block diagram illustrating the structure of a terminal according to an embodiment of the disclosure.

FIG. 6 illustrates a block diagram illustrating the structure of an NR base station according to an embodiment of the disclosure.

FIG. 7 illustrates a positioning operation in a RAN using general single quality of service (QOS) settings.

FIG. 8A illustrates a flowchart of a positioning operation in a RAN using multiple QoS requests according to an embodiment of the disclosure.

FIG. 8B illustrates a flowchart of a positioning operation in a RAN using multiple QoS requests according to an embodiment of the disclosure.

FIG. 9A illustrates a flowchart of a positioning operation through improvement of positioning reference signal (PRS) settings in case of using multiple QoS requests according to an embodiment of the disclosure.

FIG. 9B illustrates a flowchart of a positioning operation through improvement of PRS settings in case of using multiple QoS requests according to an embodiment of the disclosure.

FIG. 10A illustrates a flowchart of a positioning operation in case of requesting a separate response time for each QoS when performing multiple QoS requests according to an embodiment of the disclosure.

FIG. 10B illustrates a flowchart of a positioning operation in case of requesting a separate response time for each QoS when performing multiple QoS requests according to an embodiment of the disclosure.

### MODE FOR THE INVENTION

Hereinafter, the operation principle of the disclosure will be described in detail with reference to the accompanying drawings. In describing the disclosure hereinafter, detailed explanation of related known functions or configurations will be omitted if it is determined that it obscures the gist of the disclosure in unnecessary detail. Further, terms to be described later are terms defined in consideration of their functions in the disclosure, but may differ depending on intentions of a user or an operator, or customs. Accordingly, they should be defined on the basis of the contents of the whole description of the disclosure.

In the following description, a term to identify an access node, a term to denote network entities, a term to denote messages, a term to denote an interface between network entities, and a term to denote a variety of types of identity information have been exemplified for convenience in explanation. Accordingly, the disclosure is not limited to the terms to be described later, and other terms to denote targets having equivalent technical meanings may be used.

For convenience in explanation, in the disclosure, terms and names defined in the 3rd Generation Partnership Project Long Term Evolution (3GPP LTE) standards are used. However, the disclosure is not restricted by the terms and names, and it may be equally applied to systems complying with other standards. In the disclosure, for convenience in explanation, an eNB may be interchangeably used with a gNB. For example, a base station that is explained as an eNB may be represented as a gNB. Further, the term “terminal” may be represented as not only cellular phones, NB-IoT devices, and sensors but also other wireless communication devices.

The aspects and features of the disclosure and methods for achieving the aspects and features will be apparent by referring to the embodiments to be described in detail with reference to the accompanying drawings. However, the disclosure is not limited to the embodiments disclosed hereinafter, and it can be implemented in diverse forms. The present embodiments are provided to complete the disclosure and to completely notify those of ordinary skill in the art to which the disclosure pertains of the category of the disclosure, and the disclosure is only defined within the scope of the appended claims. In the entire description of the disclosure, the same reference numerals are used for the same elements across various figures.

In this case, it will be understood that each block of the flowchart illustrations, and combinations of blocks in the flowchart illustrations, can be performed by computer program instructions. These computer program instructions can be provided to a processor of a general purpose computer, special purpose computer, or other programmable data processing apparatus, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In this case, the term “˜unit”, as used in an embodiment, means, but is not limited to, a software or hardware component, such as field programmable gate array (FPGA) or application specific integrated circuit (ASIC), which performs certain tasks. However, “˜unit” is not meant to be limited to software or hardware. The term “˜unit” may advantageously be configured to reside on the addressable storage medium and configured to execute on one or more processors. Thus, “˜unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “˜units” may be combined into fewer components and “˜units” or further separated into additional components and “˜units”. In addition, the components and “˜units” may be implemented to operate one or more CPUs in a device or a security multimedia card. Further, in an embodiment, “˜unit” may include one or more processors.

In describing the disclosure hereunder, a detailed description of a related known function or constitution will be omitted if it is deemed to make the gist of the disclosure unnecessarily vague. Hereinafter, embodiments of the disclosure will be described with reference to the accompanying drawings.

In the following description, a term to identify an access node, a term to denote network entities, a term to denote messages, a term to denote an interface between network entities, and a term to denote a variety of types of identity information have been exemplified for convenience in explanation. Accordingly, the disclosure is not limited to the terms to be described later, and other terms to denote targets having equivalent technical meanings may be used. For example, in the following description, the “terminal” may be called as a MAC entity in the terminal that exists in each of a master cell group (MCG) and a secondary cell group (SCG).

Hereinafter, a base station is the subject that performs resource allocation to a terminal, and it may be at least one of gNode B, eNode B, Node B, base station (BS), radio access unit, base station controller, or node on a network. A terminal may include user equipment (UE), mobile station (MS), cellular phone, smart phone, computer, or multimedia system capable of performing a communication function. Of course, the base station and the terminal are not limited to the above-described examples. In particular, the disclosure may be applied to a 3GPP NR (fifth generation mobile communication standards). Further, the disclosure may be applied to intelligent services (e.g., smart homes, smart buildings, smart cities, smart cars or connected cars, healthcare, digital education, retail business, security and safety-related services, etc.) based on 5G communication technology and IoT-related technology. In the disclosure, for convenience in explanation, an eNB may be interchangeably used with a gNB. That is, a base station that is explained as an eNB may be represented as a gNB. Further, the term “terminal” may be represented as not only cellular phones, NB-IoT devices, and sensors but also other wireless communication devices.

A wireless communication system was initially developed for the purpose of providing a voice-oriented service, but has been expanded to, for example, a broadband wireless communication system that provides a high-speed and high-quality packet data service like the communication standards, such as 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

In the LTE system that is a representative example of the broadband wireless communication systems, a downlink (DL) adopts an orthogonal frequency division multiplexing (OFDM) scheme, and an uplink (UL) adopts a single carrier frequency division multiple access (SC-FDMA) scheme. The uplink means a radio link in which a terminal (e.g., user equipment (UE) or a mobile station (MS)) transmits data or a control signal to a base station (eNode B or base station (BS)), and the downlink means a radio link in which the base station transmits data or a control signal to the terminal. According to the above-described multiple access schemes, data or control information for each user is discriminated from each other by performing an allocation and an operation so as to prevent the time-frequency resources for carrying the data or control information for each user from overlapping each other, that is, to establish orthogonality.

In the communication system beyond the LTE, for example, in the 5G communication system, since it is necessary to freely reflect various requirements of users and service providers, services simultaneously satisfying the various requirements should be supported. Services being considered for the 5G communication system are enhanced mobile broadband (eMBB), massive machine type communication (mMTC), and ultra-reliability low-latency communication (URLLC).

According to some embodiments, the eMBB may aim at providing of more improved data rate than the data rate supported by the existing LTE, LTE-A, or LTE-Pro. For example, in the 5G communication system, it may be required that, from the viewpoint of one base station, the eMBB provide a peak data rate of 20 Gbps on the downlink and a peak data rate of 10 Gbps on the uplink. Further, the 5G communication system should provide a user perceived data rate of increased terminals simultaneously with providing the peak data rate. In order to satisfy such requirements, improvement of various transmission/reception technologies including more improved multi input multi output (MIMO) transmission technology is required. Further, in the 5G system, it becomes possible to satisfy the data rate required in the 5G communication system by using a frequency bandwidth that is wider than 20 MHz in the frequency band of 3 to 6 GHz or 6 GHz or more whereas in the LTE, signal transmission is performed using the maximum transmission bandwidth of 20 MHz in the 2 GHz band used in the LTE.

At the same time, in order to support application services, such as Internet of things (IoT), in the 5G communication system, the mMTC is under consideration. In order to efficiently provide the Internet of things in the mMTC, massive terminal access support, terminal coverage improvement, improved battery time, and terminal cost reduction are required in a cell. Since the Internet of things is attached to various sensors and appliances to provide communication functions, it should support a large number of terminals (e.g., 1,000,000 terminals/km²) in the cell. Further, since there is a high possibility that a terminal supporting the mMTC is located in a shaded area that is unable to be covered by the cell, such as underground of a building, due to the characteristics of the service, a wider coverage may be demanded as compared with other services being provided by the 5G communication system. The terminal supporting the mMTC should be configured as an inexpensive terminal, and since it is difficult to frequently replace a battery of the terminal, a very long battery life time, such as 10 to 15 years, may be required.

Last, the URLLC is a cellular-based wireless communication service that is used for a specific purpose (mission-critical), and may be used for services used for remote control of a robot or machinery, industrial automation, unmanned aerial vehicle, remote health care, and emergency alert. Accordingly, the communication being provided by the URLLC may have to provide a very low latency and a very high reliability. For example, a service supporting the URLLC should satisfy an air interface latency that is shorter than 0.5 milliseconds and may have packet error rate requirements of 10⁻⁵ or less at the same time. Accordingly, for the service supporting the URLLC, the 5G system should provide a transmit time interval (TTI) that is shorter than that of other services, and it requires design matters to allocate wide resources in the frequency band in order to secure reliability of a communication link at the same time.

Three kinds of services in the above-described 5G communication system, for example, the eMBB, URLLC, and mMTC may be multiplexed and transmitted by one system. In this case, in order to satisfy different requirements of the respective services, different transmission/reception techniques and transmission/reception parameters may be used between the services. However, the above-described mMTC, URLLC, and eMBB are merely an example of different service types, and the service type that is the target of application of the disclosure is not limited to the above-described example.

Further, although an embodiment of the disclosure will be described with reference to an LTE, LTE-A, LTE Pro, or 5G (or NR, next generation mobile communication) system as an example, the embodiment of the disclosure can be applied to other communication systems having similar technical background or channel type. Further, the embodiment of the disclosure can be applied to other communication systems through partial modifications thereof in the range that does not greatly deviate from the scope of the disclosure through the judgment of those having a skilled technical knowledge.

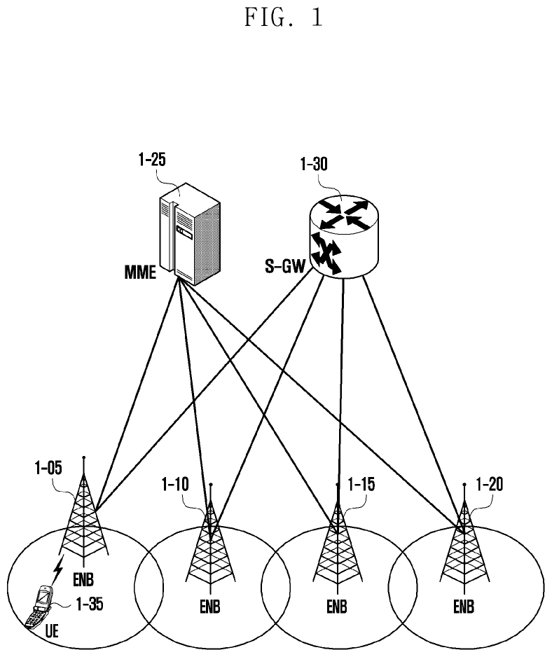

FIG. 1 illustrates a diagram illustrating the structure of an LTE system according to an embodiment of the disclosure.

With reference to FIG. 1, as illustrated, a radio access network of an LTE system may be composed of evolved node Bs (hereinafter referred to as “ENBs”, “node Bs”, or “base stations”) 1-05, 1-10, 1-15, and 1-20, a mobility management entity (MME) 1-25, and a serving-gateway (S-GW) 1-30. A user equipment (hereinafter referred to as “UE” or “terminal”) 1-35 may access an external network through the ENBs 1-05 to 1-20 and the S-GW 1-30.

In FIG. 1, the ENBs 1-05 to 1-20 may correspond to existing node Bs of a UMTS system. The ENBs 1-05 to 1-20 may be connected to the UE 1-35 on a radio channel, and may play a more complicated role than that of the existing node B. In the LTE system, since all user traffics including a real-time service, such as a voice over IP (VOIP) through an Internet protocol, may be serviced on shared channels. Accordingly, entities that perform scheduling through gathering of state information, such as a buffer state, an available transmission power state, and a channel state of UEs, may be necessary, and the ENBs 1-05 to 1-20 may take charge of the scheduling. In general, one ENB may control a plurality of cells. For example, in order to implement a transmission speed of 100 Mbps, the LTE system may use, for example, orthogonal frequency division multiplexing (hereinafter, referred to as “OFDM”) as a radio access technology in a bandwidth of 20 MHz. Further, the ENB may adopt an adaptive modulation & coding (hereinafter, referred to as “AMC”) scheme that determines a modulation scheme and a channel coding rate to match the channel state of the UE. The S-GW 1-30 is an entity that provides a data bearer, and may generate or remove the data bearer under the control of the MME 1-25. The MME is an entity that takes charge of not only a mobility management function for the UE but also various kinds of control functions, and may be connected to the plurality of base stations.

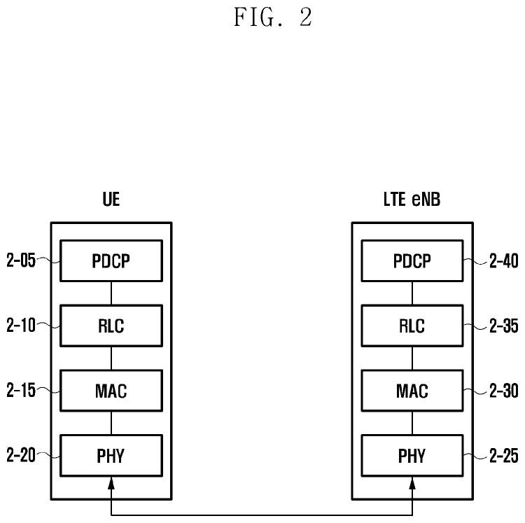

FIG. 2 illustrates a diagram illustrating a radio protocol structure of an LTE system according to an embodiment of the disclosure.

With reference to FIG. 2, in a UE or an ENB, a radio protocol of an LTE system may include a packet data convergence protocol (PDCP) 2-05 or 2-40, a radio link control (RLC) 2-10 or 2-35, a medium access control (MAC) 2-15 or 2-30, and a physical (PHY) device (or referred to as “layer”) 2-20 or 2-25. Of course, the radio protocol of the LTE system is not limited to the above-described example, and may include less or more entities than those in the above-described example.

According to an embodiment of the disclosure, the PDCP may take charge of IP header compression/decompression operations. The main functions of the PDCP may be summarized as follows. Of course, the main functions are not limited to the following examples.
Header compression and decompression: Robust header compression (ROHC) only
Transfer of user data
In-sequence delivery of upper layer PDUs at PDCP re-establishment procedure for RLC acknowledged mode (AM)
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

According to an embodiment, a radio link control (RLC) 2-10 or 2-35 may perform an ARQ operation by reconfiguring a PDCP packet data unit (PDCP PDU) with a suitable size. Main functions of the RLC may be summarized as follows. Of course, the main functions of the RLC are not limited to those in the following examples.
Transfer of upper layer PDUs
Error correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment, the MAC 2-15 or 2-30 may be connected to several RLC layer devices constituted in one UE, and may perform multiplexing of RLC PDUs into a MAC PDU and demultiplexing of the RLC PDUs from the MAC PDU. The main functions of the MAC may be summarized as follows. Of course, the main functions of the MAC are not limited to those in the following examples.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

According to an embodiment, the physical layer 2-20 or 2-25 may perform channel coding and modulation of upper layer data, and make and transmit OFDM symbols on a radio channel, or perform demodulation and channel decoding of the OFDM symbols received on the radio channel and transfer the OFDM symbols to an upper layer. Of course, the operations performed by the physical layer are not limited to those in the above-described example.

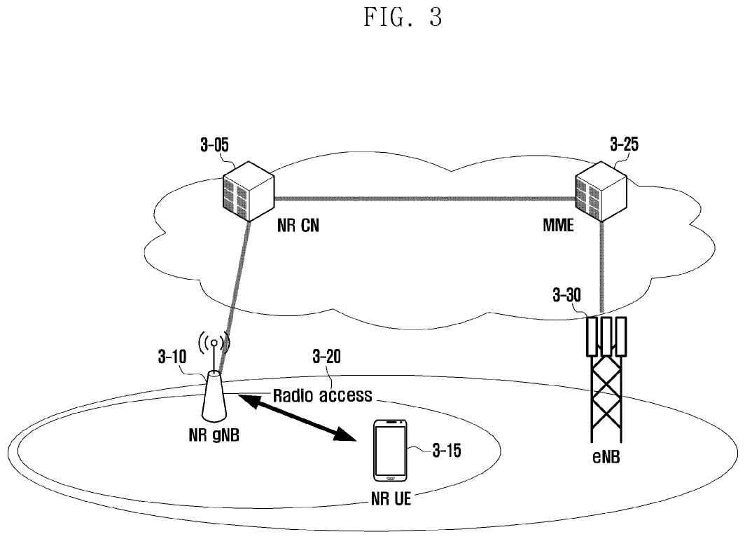

FIG. 3 illustrates a diagram illustrating the structure of a next generation mobile communication system according to an embodiment of the disclosure.

With reference to FIG. 3, a radio access network of a next generation mobile communication system (hereinafter, NR or 5G) may be composed of a new radio node B (hereinafter, NR gNB or NR base station) 3-10 and a new radio core network (NR CN) 3-05. A new radio user equipment (NR UE or terminal) 3-15 may access an external network through the NR gNB 3-10 and the NR CN 3-05.

In FIG. 3, the NR gNB 3-10 may correspond to an evolved Node B (eNB) of the existing LTE system. The NR gNB 3-10 is connected to the NR UE 3-15 on a radio channel, and can provide a more superior service than that of the existing Node B. In the next generation mobile communication system, all user traffics may be serviced on shared channels. Accordingly, there is a need for a device that performs scheduling through consolidation of state information, such as a buffer state, an available transmission power state, and a channel state of UEs, and the NR gNB 3-10 may take charge of the scheduling. One NR gNB 3-10 may control a plurality of cells. In the next generation mobile communication system, in order to implement ultrahigh-speed data transmission as compared with that of the general LTE, a bandwidth that is equal to or higher than the current maximum bandwidth may be applied. Further, an orthogonal frequency division multiplexing (OFDM) may be used as a wireless access technology, and a beamforming technology may be additionally used.

Further, according to some embodiments, the NR gNB 3-10 may adopt an adaptive modulation & coding (hereinafter, referred to as “AMC”) scheme that determines the modulation scheme and the channel coding rate to match the channel state of the UE. The NR CN 3-05 may perform functions of mobility support, bearer setup, and QoS setup. The NR CN 3-05 is an entity that takes charge of not only a mobility management function for the UE but also various kinds of control functions, and may be connected to a plurality of base stations. Further, the next generation mobile communication system may interwork with the existing LTE system, and the NR CN may be connected to the MME 3-25 through a network interface. The MME may be connected to the eNB 3-30 that is the existing base station.

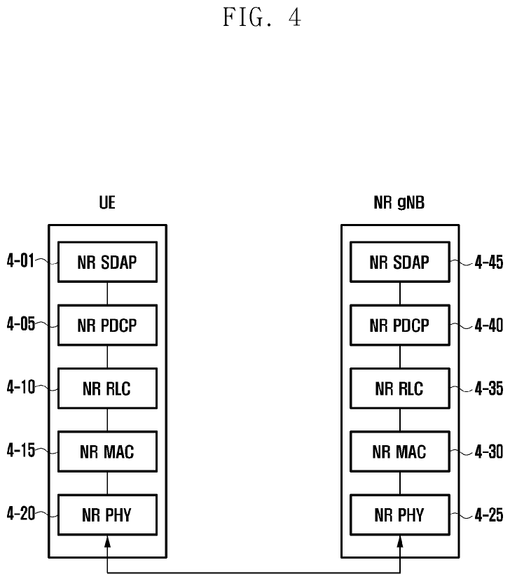

FIG. 4 illustrates a diagram illustrating a radio protocol structure of a next generation mobile communication system according to an embodiment of the disclosure. With reference to FIG. 4, in a UE and an NR base station, the radio protocol of the next generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY device (or layer) 4-20 or 4-25. Of course, the entities included in the radio protocol are not limited to the above examples, and the radio protocol may include less or more entities than those in the above-described examples.

According to an embodiment, the main functions of the NR SDAP 4-01 or 4-45 may include some of the following functions. Of course, the main functions are not limited to those in the following examples.
Transfer of user plane data
Mapping between a QoS flow and a DRB for both DL and UL
Marking QoS flow ID in both DL and UL packets
Reflective QoS flow to DRB mapping for the UL SDAP PDUs

With respect to the SDAP layer device, the UE may be configured whether to use a header of the SDAP layer device or whether to use the function of the SDAP layer device for each PDCP layer device, bearer, or logical channel through a radio resource control (RRC) message. Further, if the SDAP header is configured, the SDAP layer device may instruct the UE so that the UE can update or reconfigure mapping information on the uplink and downlink QoS flows and the data bearer by means of a non-access stratum (NAS) quality of service (QOS) reflective configuration 1-bit indicator (NAS reflective QoS) and an access stratum (AS) QOS reflective configuration 1-bit indicator (AS reflective QoS) of the SDAP header. According to some embodiments, the SDAP header may include QoS flow ID information representing the QoS. According to some embodiments, the QoS information may be used as a data processing priority for supporting a smooth service and scheduling information.

According to an embodiment, the main functions of the NR PDCP 4-05 or 4-40 may include some of the following functions. However, the main functions of the NR PDCP are not limited to the following examples.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in an uplink

In the above-described contents, reordering of the NR PDCP device may mean reordering of PDCP PDUs received from a lower layer based on PDCP sequence numbers (SNs), and may include transferring of data to an upper layer in the order of reordering, or immediate transferring of the data without considering the order, or recording of lost PDCP PDUs through reordering, or performing of status report for the lost PDCP PDUs to a transmission side, or requesting for retransmission for the lost PDCP PDUs.

The main functions of the NR RLC 4-10 or 4-35 may include some of the following functions. However, the main functions of the NR RLC are not limited to the following examples.
Transfer of upper layer PDUs
In-sequence delivery of upper layer PDUs
Out-of-sequence delivery of upper layer PDUs
Error correction through an ARQ
Concatenation, segmentation, and reassembly of RLC SDUs
Re-segmentation of RLC data PDUs
Reordering of RLC data PDUs
Duplicate detection
Protocol error detection
RLC SDU discard
RLC reestablishment

In the above-described contents, the in-sequence delivery of the NR RLC device may mean transferring of RLC SDUs received from a lower layer to an upper layer in order.

In case that one original RLC SDU is segmented into several RLC SDUs and received, the in-sequence delivery of the NR RLC device may include reassembly and delivery of the RLC SDUs.

The in-sequence delivery of the NR RLC device may include reordering of the received RLC PDUs based on an RLC sequence number (SN) or a PDCP sequence number (SN), recording of the lost RLC PDUs through reordering, performing of status report for the lost RLC PDUs to the transmission side, or requesting for retransmission for the lost RLC PDUs.

The in-sequence delivery of the NR RLC device may include transferring of only RLC SDUs just before the lost RLC SDU to an upper layer in order if there is the lost RLC SDU.

The in-sequence delivery of the NR RLC device may include transferring of all RLC SDUs received before a specific timer starts its operation to an upper layer in order if the timer has expired although there is the lost RLC SDU.

The in-sequence delivery of the NR RLC device may include transferring of all RLC SDUs received up to now to an upper layer in order if the specific timer has expired although there is the lost RLC SDU.

The NR RLC device may process the RLC PDUs in the order of their reception regardless of the order of the sequence number (out of sequence delivery), and may transfer the processed RLC PDUs to the NR PDCP device.

In case of receiving segments, the NR RLC device may receive the segments stored in a buffer or to be received later, reconfigure them as one complete RLC PDU, and then transfer the reconfigured RLC PDU to the NR PDCP device.

The NR RLC layer may not include a concatenation function, and the function may be performed by an NR MAC layer or may be replaced by a multiplexing function of the NR MAC layer.

In the above-described contents, the out-of-sequence delivery of the NR RLC device may mean a function of immediately transferring the RLC SDUs received from a lower layer to an upper layer regardless of their order. If one original RLC SDU is segmented into several RLC SDUs and received, the out-of-sequence delivery of the NR RLC device may include reassembly and delivery of the RLC SDUs. The out-of-sequence delivery of the NR RLC device may include functions of storing and ordering the RLC SNs or PDCP SNs of the received RLC PDUs and recording the lost RLC PDUs.

According to some embodiments, the NR MAC 4-15 or 4-30 may be connected to several NR RLC layer devices constituted in one UE, and the main functions of the NR MAC may include some of the following functions. However, the main functions of the NR MAC are not limited to the following examples.
Mapping between logical channels and transport channels
Multiplexing/demultiplexing of MAC SDUs
Scheduling information reporting
HARQ function (error correction through HARQ)
Priority handling between logical channels of one UE
Priority handling between UEs by means of dynamic scheduling
MBMS service identification
Transport format selection
Padding

The NR PHY layer 4-20 or 4-25 may perform channel coding and modulation of upper layer data to make and transmit OFDM symbols on a radio channel, or may perform demodulation and channel decoding of the OFDM symbols received on the radio channel to transfer the demodulated and channel-decoded symbols to an upper layer. Of course, operations of the NR PHY layer are not limited to the above-described examples.

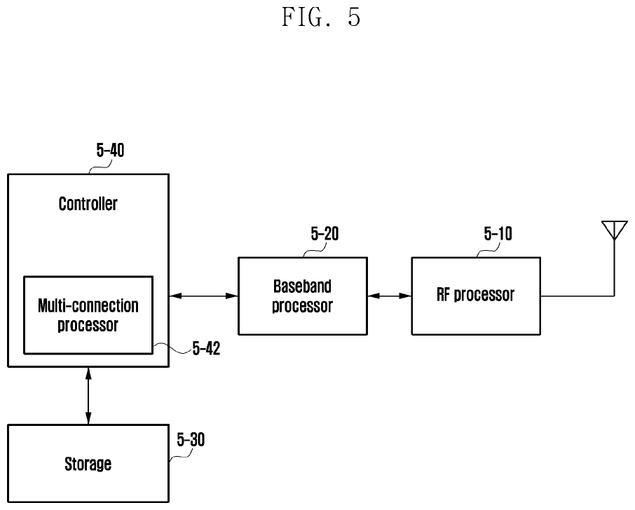

FIG. 5 illustrates a block diagram illustrating the inner structure of a terminal according to an embodiment of the disclosure.

With reference to FIG. 5, a terminal may include a radio frequency (RF) processor 5-10, a baseband processor 5-20, a storage unit 5-30, and a controller 5-40. Also, the controller 5-40 may further include a multi-connection processor 5-42. Of course, the constitutions of the terminal are not limited to the above-described examples, and the terminal may include less or more constitutions than those illustrated in FIG. 5. For example, the terminal may include a transceiver for transmitting and receiving a signal and a controller as constituent elements.

The RF processor 5-10 may perform a function for transmitting and receiving a signal on a radio channel, such as signal band conversion and amplification. The RF processor 5-10 may perform up-conversion of a baseband signal provided from the baseband processor 5-20 into an RF-band signal to transmit the converted signal through an antenna, and perform down-conversion of the RF-band signal received through the antenna into a baseband signal. For example, the RF processor 5-10 may include a transmission filter, a reception filter, an amplifier, a mixer, an oscillator, a digital-to-analog converter (DAC), and an analog-to-digital converter (ADC). Of course, the constitutions of the RF processor 5-10 are not limited to the above-described examples. Although only one antenna is illustrated in FIG. 5, the terminal may be provided with a plurality of antennas. Further, the RF processor 5-10 may include a plurality of RF chains. Further, the RF processor 5-10 may perform beamforming. For the beamforming, the RF processor 5-10 may adjust phases and sizes of signals being transmitted and received through the plurality of antennas or antenna elements. Further, the RF processor 5-10 may perform multi input multi output (MIMO), and may receive several layers during performing of the MIMO operation.

The baseband processor 5-20 performs a conversion function between a baseband signal and a bit string in accordance with the physical layer standard of the system. For example, during data transmission, the baseband processor 5-20 generates complex symbols by encoding and modulating a transmitted bit string. Further, during data reception, the baseband processor 5-20 may restore a received bit string by demodulating and decoding the baseband signal being provided from the RF processor 5-10. For example, in case of complying with an orthogonal frequency division multiplexing (OFDM) scheme, during data transmission, the baseband processor 5-20 generates complex symbols by encoding and modulating a transmitted bit string, performs mapping of the complex symbols onto subcarriers, and then constitutes OFDM symbols through an inverse fast Fourier transform (IFFT) operation and cyclic prefix (CP) insertion. Further, during data reception, the baseband processor 5-20 may divide the baseband signal being provided from the RF processor 5-10 in the unit of OFDM symbols, restore the signals mapped onto the subcarriers through the fast Fourier transform (FFT), and then restore the received bit string through demodulation and decoding.

The baseband processor 5-20 and the RF processor 5-10 transmit and receive the signals as described above. The baseband processor 5-20 and the RF processor 5-10 may be called a transmitter, a receiver, a transceiver, or a communication unit. Further, in order to support different radio access technologies, at least one of the baseband processor 5-20 and the RF processor 5-10 may include a plurality of communication modules. Further, in order to process signals of different frequency bands, at least one of the baseband processor 5-20 and the RF processor 5-10 may include different communication modules. For example, the different radio access technologies may include a wireless LAN (e.g., IEEE 802.11) and a cellular network (e.g., LTE). Further, the different frequency bands may include super high frequency (SHF) (e.g., 2.NR Hz or NR Hz) band and millimeter (mm) wave (e.g., 60 GHz) band. The terminal may transmit or receive a signal to or from the base station by using the baseband processor 5-20 and the RF processor 5-10, and the signal may include control information and data.

The storage unit 5-30 stores therein a basic program for an operation of the terminal, application programs, and data of configuration information. In particular, the storage unit 5-30 may store information related to a second access node that performs wireless communication by using a second radio access technology. Further, the storage unit 5-30 provides stored data in accordance with a request from the controller 5-40. The storage unit 5-30 may be composed of storage media, such as a ROM, RAM, hard disk, CD-ROM, and DVD, or a combination of the storage media. Further, the storage unit 5-30 may be composed of a plurality of memories.

The controller 5-40 controls the overall operations of the terminal. For example, the controller 5-40 transmits and receives signals through the baseband processor 5-20 and the RF processor 5-10. Further, the controller 5-40 records or reads data in or from the storage unit 5-30. For this, the controller 5-40 may include at least one processor. For example, the controller 5-40 may include a communication processor (CP) that performs a control for communication and an application processor (AP) that controls an upper layer, such as an application program. Further, at least one constitution of the terminal may be implemented as one chip. According to an embodiment of the disclosure, the controller 5-40 may control to receive a request for location information about a plurality of QoS levels, perform measurement that satisfies the received QoS levels, and transmit, to the LMF, the measurement result and an indicator for an accuracy value corresponding to the measurement result. Hereinafter, an operation method of the terminal according to an embodiment of the disclosure will be described in more detail.

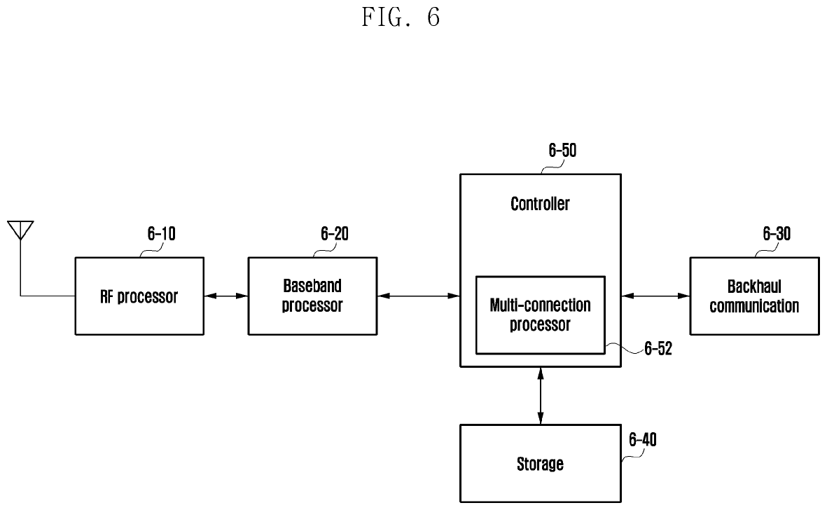

FIG. 6 illustrates a block diagram illustrating the structure of an NR base station according to an embodiment of the disclosure.

With reference to FIG. 6, the base station may include an RF processor 6-10, a baseband processor 6-20, a backhaul communication unit 6-30, a storage unit 6-40, and a controller 6-50. Also, the controller 6-50 may further include a multi-connection controller 6-52. Of course, the constitutions of the base station are not limited to the above-described examples, and the base station may include less or more constitutions than those illustrated in FIG. 6. For example, the base station may include a transceiver for transmitting and receiving a signal and a controller as constituent elements.

The RF processor 6-10 may perform a function for transmitting and receiving signals on a radio channel, such as signal band conversion and amplification. For example, the RF processor 6-10 performs up-conversion of a baseband signal provided from the baseband processor 6-20 into an RF-band signal to transmit the converted signal through an antenna, and performs down-conversion of the RF-band signal received through the antenna into a baseband signal. For example, the RF processor 6-10 may include a transmission filter, a reception filter, an amplifier, a mixer, an oscillator, a DAC, and an ADC. Although only one antenna is illustrated in FIG. 6, the RF processor 6-10 may be provided with a plurality of antennas. Further, the RF processor 6-10 may include a plurality of RF chains. Further, the RF processor 6-10 may perform beamforming. For the beamforming, the RF processor 6-10 may adjust phases and sizes of signals being transmitted or received through the plurality of antennas or antenna elements. The RF processor may perform a downward MIMO operation through transmission of one or more layers.

The baseband processor 6-20 may perform a conversion function between a baseband signal and a bit string in accordance with the physical layer standard of the first radio access technology. For example, during data transmission, the baseband processor 6-20 may generate complex symbols by encoding and modulating a transmitted bit string. Further, during data reception, the baseband processor 6-20 may restore a received bit string by demodulating and decoding the baseband signal provided from the RF processor 6-10. For example, in case of complying with an OFDM scheme, during data transmission, the baseband processor 6-20 generates complex symbols by encoding and modulating a transmitted bit string, performs mapping of the complex symbols to subcarriers, and then configures OFDM symbols through the IFFT operation and CP insertion. Further, during data reception, the baseband processor 6-20 may divide the baseband signal provided from the RF processor 6-10 in the unit of OFDM symbols, restore the signals mapped to the subcarriers through the FFT operation, and then restore the received bit string through demodulation and decoding.

The baseband processor 6-20 and the RF processor 6-10 may transmit and receive the signals as described above. Accordingly, the baseband processor 6-20 and the RF processor 6-10 may be called a transmitter, a receiver, a transceiver, a communication unit, or a wireless communication unit. The base station may transmit or receive a signal to or from the terminal by using the baseband processor 6-20 and the RF processor 6-10, and the signal may include control information and data. The backhaul communication unit 6-30 provides an interface for performing communication with other nodes in the network. That is, the backhaul communication unit 6-30 may convert a bit string being transmitted from the primary base station to other nodes, for example, an auxiliary base station and a core network, into a physical signal, and convert the physical signal being received from other nodes into a bit string. The backhaul communication unit 6-30 may be included in the communication unit.

The storage unit 6-40 stores therein a basic program for an operation of the main base station, application programs, and data of configuration information. The storage unit 6-40 may store information about a bearer allocated to the connected terminal and the measurement result reported from the connected terminal. Further, the storage unit 6-40 may store information that becomes the basis of determination of whether to provide or suspend a multi-connection to the terminal. Further, the storage unit 6-40 provides stored data in accordance with a request from the controller 6-50. The storage unit 6-40 may be composed of storage media, such as a ROM, RAM, hard disk, CD-ROM, and DVD, or a combination of the storage media. Further, the storage unit 5-30 may be composed of a plurality of memories. According to some embodiments, the storage unit 6-40 may store a program for performing a buffer state reporting method according to the disclosure.

The controller 6-50 controls the overall operation of the primary base station. For example, the controller 6-50 transmits and receives signals through the baseband processor 6-20 and the RF processor 6-10 or through the backhaul communication unit 6-30. Further, the controller 6-50 records or reads data in or from the storage unit 6-40. For this, the controller 6-50 may include at least one processor. Further, at least one constitution of the base station may be implemented as one chip.

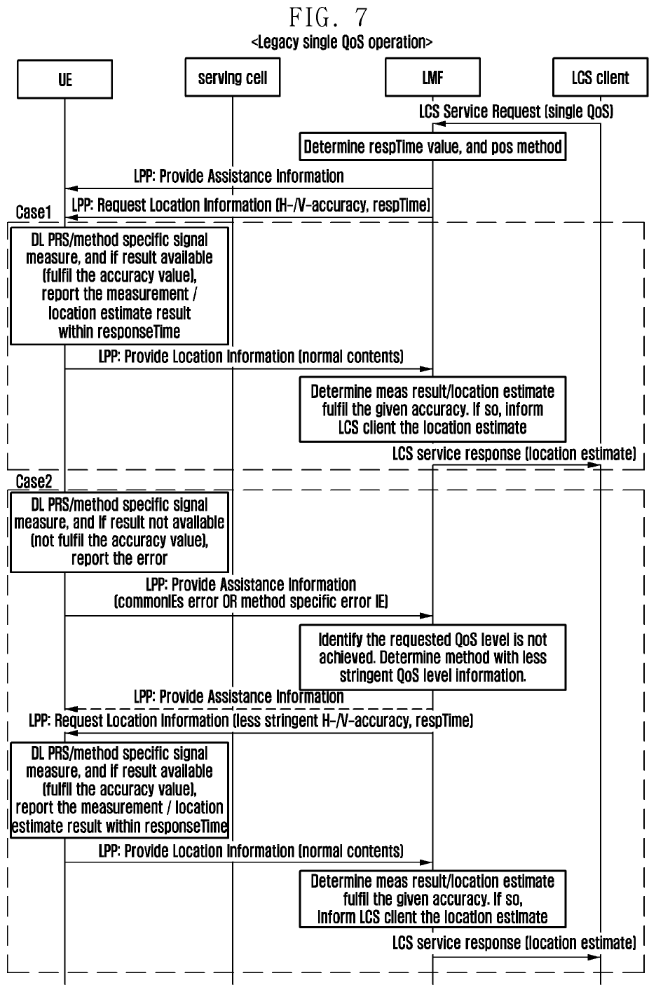

In the disclosure, in order to solve the caused problems, a location-based serve r may transfer multiple quality-of-service factors to a terminal by using one me ssage, and the terminal may perform measurement according to a specific priori ty and determine whether a given quality-of-service factor is satisfied. If not sa tisfied, the terminal itself may perform measurement for another quality-of-servi ce factor. In this process, it is not necessary to send and receive an additional signal with the LMF. FIG. 7 is a flowchart disclosing a positioning operation in a RAN using general single QoS settings.

In a general positioning operation, a location management function (LMF) may receive an LCS service request from a location services (LCS) client. The LCS client provides one piece of QOS information, and requests location information based on the indicated QoS level. In this case, parameters transferred from the LCS client to the LMF may include a QoS class, a horizontal accuracy, a vertical accuracy, and a response time.

The LMF having received that above contents may determine a suitable positioning method in consideration of the received parameters, determine a response time value, and transfer determined information to a target terminal (LPP RequestLocationInformation message). In this case, assistance information may be first transferred to the target terminal.

As in CASE 1 of FIG. 7, the target terminal having received the information may measure a downlink (DL) positioning reference signal (PRS) (in case that a RAT-dependent method is indicated) or a method specific signal (in case that a RAT-independent method is indicated), and if the measurement result that satisfies the accuracy value of the QoS is present, the target terminal may transmit, to the LMF, the corresponding measurement result and/or a location estimate based on the measurement result. The location estimate may be transmitted from the LMF within a given response time (LPP ProvideLocationInformation message).

The LMF having received the above contents may identify whether the measurement result suits the QoS level desired by the LMF itself. For example, if the measurement result satisfies the accuracy in which the LMF has instructed the terminal, the LMF may transfer the location estimate that suits the measurement result to the LCS client.

As in CASE 2 of FIG. 7, if the result by the measurement of the terminal does not satisfy the given QoS level (e.g., if the measurement result does not satisfy the accuracy in which the LMF has instructed the terminal), the terminal may transmit an error message to the LMF in relation to this. The error message may be indicated as a cause value of an error related to a common IE in an LPP ProvideLocationInformation message, or may be indicated in the error message for each performed method. The LMF having received the message may identify that the QoS level desired by the LMF itself is not satisfied. Further, the LMF may determine an accuracy value corresponding to a lower QoS level, and may again request the location information from the same terminal (LPP RequestLocationInformation). The terminal having received the message may measure a DL PRS or method specific signal, and may determine whether the accuracy value corresponding to the given lower QoS level is satisfied. If it is satisfied, the terminal may transmit, to the LMF, the corresponding measurement result or the location estimate according to the result. The LMF may identify whether the QoS level instructed by the LMF itself is satisfied through seeing the result. If it is satisfied after identification, for example, if the measurement result satisfies the accuracy in which the LMF has instructed the terminal, the LMF may transmit, to the LCS client, the location estimate calculated from the measurement result (or directly received from the terminal).

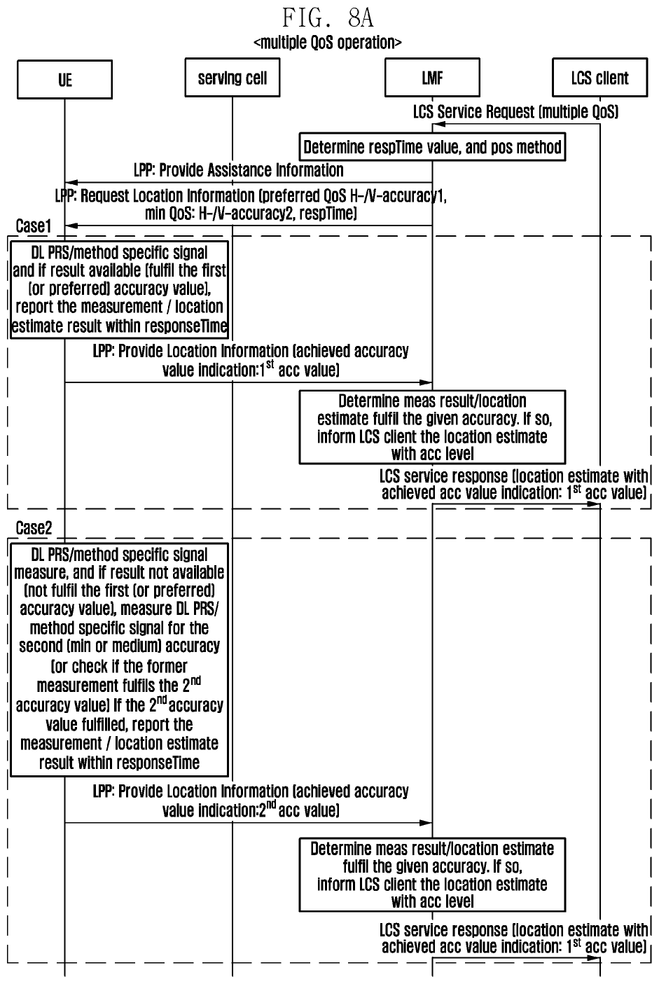

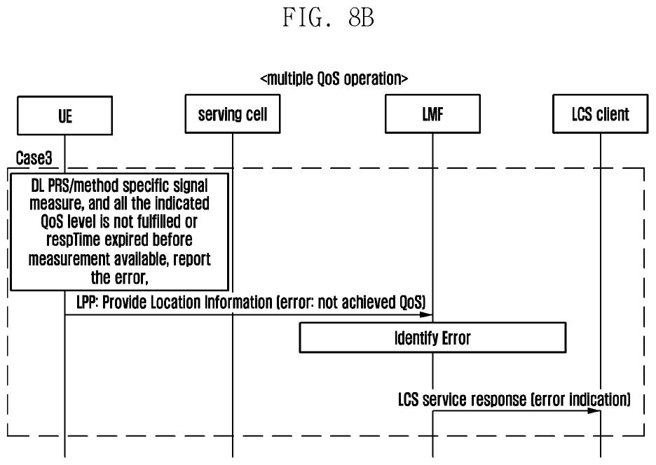

The method proposed in the disclosure may be used for the purpose of reducing a signaling delay time due to the second attempt. For example, as described above with reference to FIG. 7, if the QoS level is not satisfied, the terminal may first transmit the error message to the LMF, and the LMF having identified the error message instructs again the terminal in the accuracy value corresponding to the lower QoS level, resulting in that a signaling delay occurs. As an embodiment of the disclosure to solve the above problems, a positioning operation in a RAN using multiple QoS requests will be described with reference to FIGS. 8A and 8B

As illustrated in FIG. 8A, an LMF may receive, from an LCS client, an LCS service request including a multiple QoS class indicator and corresponding multiple accuracy and response time information. In this case, the LMF may instruct a terminal in multiple QoS level accuracy information. When instructing the above information, the LMF may add following information to an LPP RequestLocationInformation message. The LMF may include two or more accuracy values. For example, two or three accuracy values may be included in a CommonIEsRequestLocationInformation part.

The accuracy value is a value representing the maximum allowable error with the concept of distance or uncertainty. In case that two accuracy values are included, they may mean a preferred QoS level accuracy and the minimum QoS level accuracy, respectively. In case that three accuracy values are included, they may mean a preferred QoS level accuracy, an intermediate level accuracy, and the minimum QoS level accuracy, respectively. The preferred QoS level accuracy may mean the highest QoS level. The minimum QoS level accuracy may mean the lowest QoS level.

The accuracy may additionally include a horizontal accuracy and a vertical accuracy. Further, the horizontal/vertical accuracy may have a separate confidence level. The above information may be equally included in a RequestLocationInformation part of each positioning method.

As in CASE 1 of FIG. 8A, if the terminal receives the above message, it may first perform an operation for fulfilling the preferred QoS level accuracy. For example, the terminal may measure a signal for each DL PRS or each designated positioning method, and may determine whether the corresponding measurement result satisfies the preferred QoS level accuracy. If the measurement result satisfies the preferred QoS level accuracy, the terminal may transmit the corresponding measurement result or location estimate based on the measurement result to the LMF. At this time, in case that the transmitted message includes an indicator indicating of what QoS level the measurement is satisfied, an indicator indicating that the preferred QoS level accuracy is satisfied may be included.

As in CASE 2 of FIG. 8A, if the measurement does not satisfy the preferred QoS level, the terminal may measure the DL PRS or pre-designated positioning method specific signal by itself (without LMF's instructions), and may determine whether the measurement satisfies the accuracy of the highest QoS level next to the preferred QoS level. Further, the terminal may determine whether the measurement information performed in the previous step satisfies the accuracy of the highest QoS level next to the preferred QoS level without measurement of an additional signal. If the measurement information satisfies the next highest QoS level, the terminal may include an indicator for the satisfied QoS level together with the measurement result and the location estimate result. In case that two QoS levels are pre-instructed, the minimum QoS level may be indicated, and in case that three QoS level are pre-instructed, the intermediate QoS level may be indicated.

As in CASE 3 of FIG. 8B, if not satisfied in a state where two QoS levels are pre-instructed, the terminal may include, in the LPP ProvideLocationInformation message, an error message/indicator representing that the measurement result does not satisfy the all accuracy values given to the common IE part or the method specific part, and may transfer the LPP ProvideLocationInformation message to the LMF.

If three QoS levels are pre-instructed, the terminal may measure the DL PRS or pre-designated positioning method specific signal by itself (without LMF's instructions), and may determine whether the minimum QoS level accuracy is satisfied or whether the measurement information performed in the previous step satisfies the minimum QoS level accuracy. If the minimum QoS level accuracy is satisfied, the terminal may include an indicator for the satisfied QoS level together with the measurement result and the location estimate result. In case that three QoS levels are pre-instructed, the minimum QoS level may be indicated. If the measurement result of the terminal does not satisfy the minimum QoS level accuracy, as in CASE 2 of FIG. 8B, the terminal may include the error message/indicator representing that the measurement result does not satisfy the all accuracy values in LPP ProvideLocationInformation message to be transmitted to the LMF.

If the response time expires while performing the measurement and determination of whether to satisfy the accuracy, the terminal may include an indicator for timer expiration in the ProvideLocationInformation message to be transferred, and in this case, the measurement result may be included regardless of satisfaction of the accuracy.

In the disclosure, in case of the RAT-dependent method, the measurement result may mean a DL PRS measurement signal strength and a time difference of reception signals with a reference transmit/receive point (TRP). Further, in case of the RAT-independent method, the measurement result may be various kinds of information obtained by measuring the signal of each method, and may be values included in the ProvideLocationInformation IE of the existing RAT independent method.

According to the above embodiments, a new message included in the LPP ProvideLocationInformation message may be an indicator for the satisfied QoS level, and may be a one or two bit indicator. Further, through an NR-TimingQuality field, specific acceptable distance information may be expressed in combination of a quality value and quality resolution. The value is a specific integer value, and the resolution is a specific distance unit, and may express the distance information of the accuracy through multiplication of the value and the resolution. Further, this value may be expressed as uncertainty. Since this value can express not only the accuracy value of the actually given QoS level accuracy but also a certain accuracy value, it may be used when the terminal expresses the specific accuracy y value that exceeds the given QoS level accuracy.

In FIGS. 8A and 8B, CASE 1 discloses a process in which, if the LMF has received multiple QoS configuration information from the LCS client, the LMF includes the accuracy values for the multiple QoS and the response time in the LPP ProvideLocationInformation message and transmits the LPP ProvideLocationInformation message to the terminal, and if the measurement result of the terminal is successful against the preferred accuracy, the terminal reports, to the LMF, the measurement result value together with the arrived QoS accuracy value indicator.

CASE 2 discloses a process in which, if the measurement value for the preferred QoS level accuracy is not satisfied in case that the accuracy values for the multiple QoS are configured in the LPP ProvideLocationInformation, the terminal identifies the accuracy satisfaction according to the next highest QoS level (i.e., measurement of the signal for each DL PRS or pre-designated method for the identification may be first performed), and if it is satisfied, the terminal includes and reports the measurement result and the accuracy indicator of the satisfied QoS level to the LMF. The LMF having received the report reports the location estimate corresponding to the measurement result value to the LCS client, and in this case, the indicator for the satisfied QoS level may also be included and transferred.

Last, CASE 3 corresponds to a case where all the given QoS level accuracies are not satisfied, and the error indicator is included and reported to the LMF. The error message may mean the meaning of “not all result are available”, or may be a Boolean 1 bit indicator that simply means a failure.

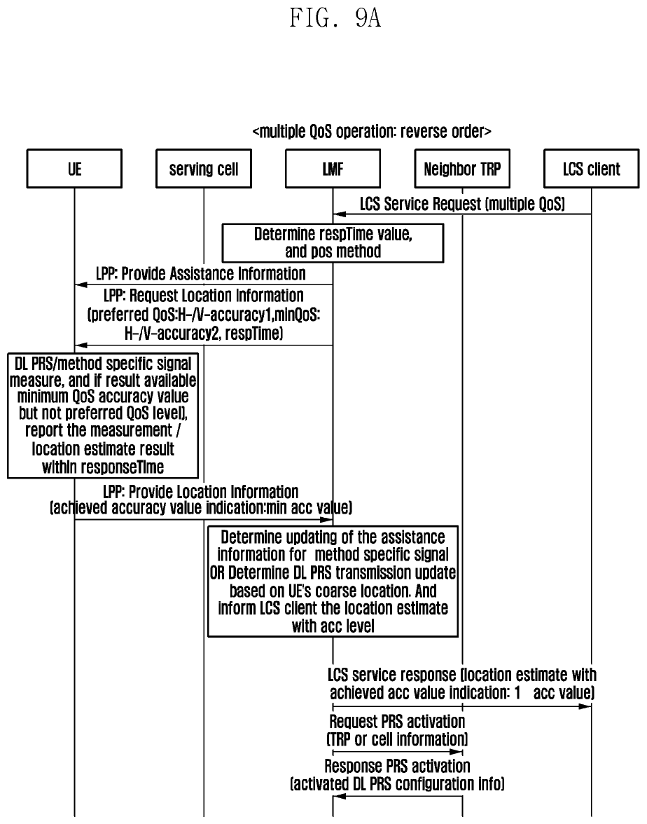

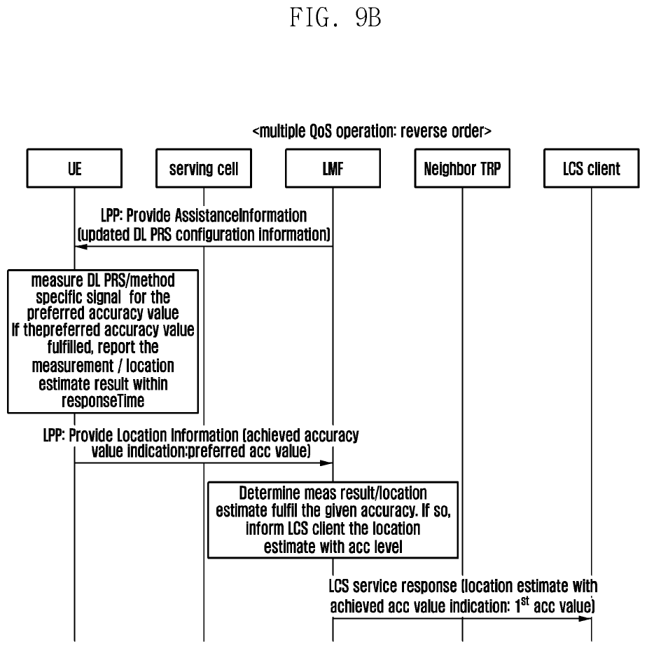

FIGS. 9A and 9B are flowcharts illustrating a positioning operation through improvement of PRS settings in case of using multiple QoS requests according to another embodiment of the disclosure.

In an embodiment disclosed in FIGS. 9A and 9B, in case that the terminal receives multiple QoS requests from the LMF, the terminal may perform measurement and availability identification process from a low QoS level. The order for the terminal to perform the measurement may be minimum→intermediate→preferred (in case that 3 QoS levels are given), or minimum→preferred (in case that 2 QoS levels are given).

Accordingly, if the accuracy for the multiple QoS levels is given, the terminal may measure the signal that is used in the DL PRS or the given method, and may determine whether the accuracy value corresponding to the minimum QoS level is satisfied. If the accuracy value is satisfied, the terminal may transfer, to the LMF, the corresponding measurement value including the indicator for the satisfied QoS level accuracy. In case of the RAT-dependent method, the LMF having received the information may grasp an approximate location where the current terminal is located from the reported measurement result, and may activate a larger number of PRSs in a required TRP, or may request DL PRS transmission configuration from a newly related TRP in a direction in which the number/frequency of repetitions of the existing PRS is increased. For example, the LMF may determine an update of assistance information based on the measurement result received from the terminal. Further, the LMF may determine an update of DL PRS transmission based on the measurement result received from the terminal. Accordingly, the LMF may transmit an LCS service response to the LCS client. Further, the LMF may request PRS activation from the TRP by using an NRPPa message, and the TRP having received the request may give an activation response to the corresponding request PRS. As described above, based on the response received from the related TRP, the LMF may transfer the new DL PRS updated information to the terminal through a ProvideAssistanceInformation message.

As illustrated in FIG. 9B, in case of the RAT-independent method, the LMF may newly update and give the assistance information of the reference signals related to the RAT-dependent method to the terminal. For example, in case of a GNSS, if there is satellite information that produces the more reliable result in a specific location, the LMF may additionally find out the corresponding satellite information through the measurement result that satisfies the minimum QoS level accuracy, and may give the terminal the assistance information so that the terminal measures the signal of the satellite.

The terminal having received the assistance information updated as above may perform an additional measurement operation by newly considering the reference signal information of the corresponding DL PRS or RAT-independent method. Further, if the result value satisfies the accuracy of the QoS level that is higher than the minimum QoS level among the previously given multiple QoS, the terminal may include and transfer the measurement result value and the satisfied QoS level accuracy indicator information to the LMF.

For example, the LMF may determine whether the measurement result received from the terminal or the location estimate based on the measurement result satisfies the predetermined accuracy. If it is determined to be satisfied as the result of the determination, the LMF may transmit an LCS service response message to the LCS client. In this case, the LMF may transmit the measurement result value received from the terminal and the satisfied QoS level accuracy indicator information together.

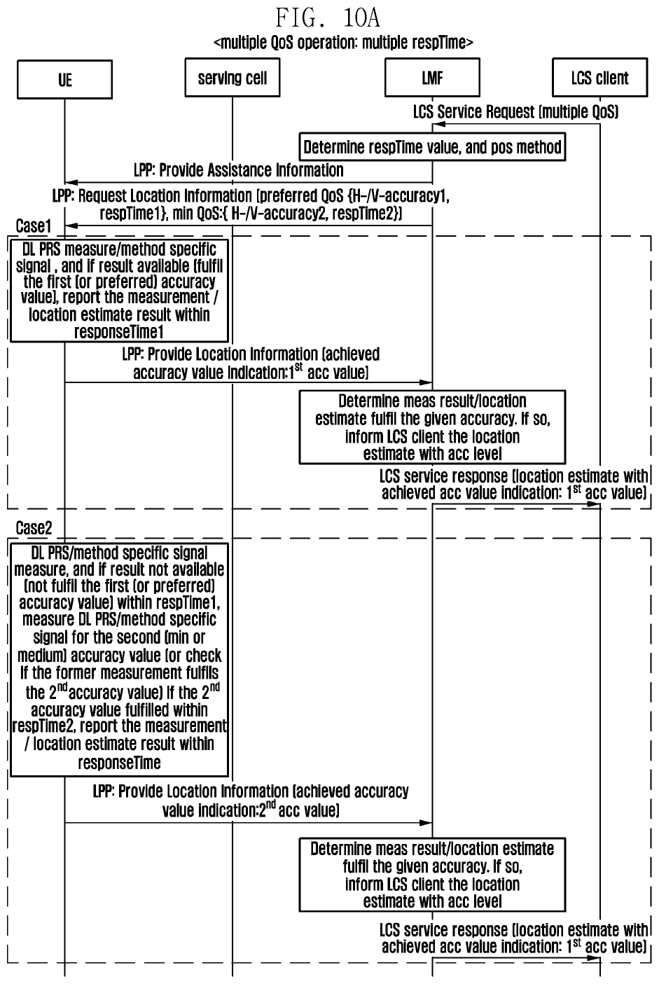

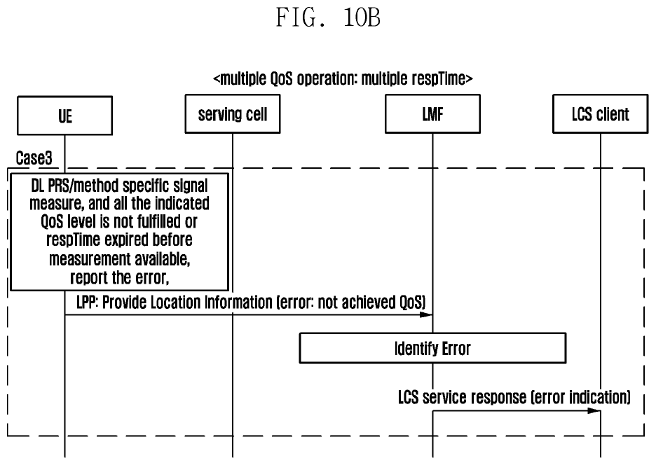

FIGS. 10A and 10B are flowcharts illustrating a positioning operation in case of requesting a separate response time for each QoS when performing multiple QoS requests as one embodiment.

As another embodiment, when the LMF transfers factors for multiple QoS levels to the terminal, it may also transmit a response time separately in addition to horizontal and/or vertical accuracies for each QoS level. When the LMF transfers the service request from the LCS client, it transfers only the accuracy value for the multiple QoS for each QoS, and transfers only one response time. However, although the LMF transfers the accuracy values to the terminal as they are, it may configure the response time according to each QoS level as a specific value. For example, the following information may be included in the LPP RequestLocationInformation message.

Preferred QoS level: Horizontal accuracy 1, vertical accuracy 1, and response time 1 Intermediate QoS level: Horizontal accuracy 2, vertical accuracy 2, and response time 2

Minimum QoS level: Horizontal accuracy 3, vertical accuracy 3, and response time 3 During measurement, the terminal having received the message may identify the QoS accuracy satisfaction of each level, and if the QoS accuracy is satisfied, the terminal may report the measurement, whereas if the measurement of the QoS accuracy has failed, the terminal may apply a valid time as a value signaled for each QoS level until an operation of determining the accuracy satisfaction of another QoS level starts. For example, the measurement of the preferred level and determination of whether to satisfy the level may be performed for the response time 1. Further, in case of a failure at the previous level, whether to satisfy the next QoS level may also follow the response time signaled for the corresponding level.

For example, as illustrated in CASE 1 of FIG. 10A, if the terminal determines the measurement for the preferred level and whether to satisfy the level for the response time 1, the terminal may include and transfer the measurement result value and the satisfied QoS level accuracy indicator information to the LMF. The LMF may determine whether the measurement result received from the terminal or the location estimate based on the measurement result satisfies the predetermined accuracy.

Further, the LMF may transmit the LCS service response message to the LCS client. In this case, the LMF may transmit the measurement result value received from the terminal and the satisfied QoS level accuracy indicator information together.

Further, as illustrated in CASE 2 of FIG. 10A, if the terminal is unable to determine the measurement for the preferred level (first QoS level) and whether to satisfy the level for the response time 1, the terminal may determine the measurement for the minimum level (second QoS level) and whether to satisfy the level for the response time 2. According to an embodiment, if the measurement for minimum level (second QoS level) for the response time 2 and the measurement result satisfy the level, the terminal may include and transfer the measurement result value and the satisfied QoS level accuracy indicator information (second accuracy value) to the LMF. The LMF may determine whether the measurement result received from the terminal or the location estimate based on the measurement result satisfies the predetermined accuracy. Further, the LMF may transmit the LCS service response message to the LCS client. In this case, the LMF may transmit the measurement result value received from the terminal and the satisfied QoS level accuracy indicator information together. In this case, the measurement and the fulfillment check operation may be performed in the order of the minimum QoS, the intermediate QoS, and the preferred QoS.

As illustrated in CASE 3 of FIG. 10B, in case that all the instructed QoS levels are not satisfied although the terminal has performed the measurement according to the plurality of QoS level and the response times configured to the respective levels, and all the response times have expired, The terminal may transmit an error message to the LMF. In this case, the LMF may identify the error, and may transmit an LCS service response including an error indicator to the LCS client.

In relation to the response time values, through the existing field that is referred to as a timer so called responseTimeEarlyFix, if the timer (responseTimeEarlyFix) has expired in spite of dissatisfaction of the given QoS level, the terminal sometimes transferred the information measured up to the timer expiration time to the LMF. Considering a case of transmitting the intermediate result of FIGS. 9A and 9B, the above-described field may be reused. In this case, the LMF may transmit the responseTimeEarlyFix value in addition to the H/V-accuracy value of the minimum QoS level. Through this, the terminal may perform the measurement of the minimum QoS level and the identification of satisfaction or not until the expiration of the timer. For example, in case that the above field is used together with the multiple QoS, and the accuracy value of the QoS level associated with the corresponding field is satisfied, the terminal may include and report the measurement result value and the satisfied QoS level indicator to the LMF.

According to the above-described embodiments, the LMF may receive the measurement result for the possible QoS level from the terminal, without additional signaling with the terminal, through the use of the multiple QoS requests from the terminal.

Methods according to the claims or the embodiments described in the specification may be implemented in the form of hardware, software, or a combination of hardware and software.

In case of implementation by software, a computer readable storage medium storing one or more programs (software modules) may be provided. The one or more programs stored in the computer readable storage medium are configured for execution by one or more processors in the electronic device. The one or more programs include instructions causing the electronic device to execute the methods according to the claims of the disclosure or the embodiments described in the specification.

Such programs (software modules or software) may be stored in a nonvolatile memory including a random access memory and a flash memory, a read only memory (ROM), an electrically erasable programmable read only memory (EEPROM), a magnetic disc storage device, a compact disc-ROM (CD-ROM), a digital versatile discs (DVDs), or other types of optical storage devices, and a magnetic cassette. Further, the programs may be stored in a memory composed of a combination of some or all of them.

Further, a plurality of memories may be included in the respective configurations.

Further, the programs may be stored in an attachable storage device that can be accessible through a communication network composed of the Internet, Intranet, local area network (LAN), a wide LAN (WLAN), or a communication network, such as a storage area network (SAN), or a communication network composed of a combination thereof. Such a storage device may be connected to a device that performs an embodiment of the disclosure through an external port. Further, a separate storage device on a communication network may be connected to the device that performs the embodiment of the disclosure.

In the above-described detailed embodiments of the disclosure, the elements included in the disclosure may be expressed in the singular or plural form depending on the proposed detailed embodiment. However, the singular or plural expression has been selected suitably for a situation proposed for convenience of description, and the disclosure is not limited to the singular or plural elements. Although an element has been expressed in the plural form, it may be configured in the singular form. Although an element has been expressed in the singular form, it may be configured in the plural form.

Although specified embodiments have been described in the detailed description of the disclosure, the disclosure may be modified in various ways without departing from the scope of the disclosure. Accordingly, the scope of the disclosure should not be limited to the above-described embodiments, but should be defined by not only the claims but also equivalents thereof. That is, it will be apparent to those of ordinary skill in the art to which the disclosure pertains that other modification examples based on the technical concept of the disclosure can be embodied. Further, as needed, the respective embodiments may be operated in combination. For example, some of the methods proposed in the disclosure may be combined to operate the base station and the terminal. Further, although the above-described embodiments have been proposed based on the 5G or NR system, other modification examples based on the technical idea of the embodiments will be able to be embodied even in other systems, such as LTE, LTE-A, and LTE-A-Pro systems.

The embodiments of the disclosure disclosed in the specification and drawings are merely to present specific examples in order to facilitate the explanation of the contents of the disclosure and to help understanding of the disclosure, but are not intended to limit the scope of the disclosure. It is apparent to those of ordinary skill in the art to which the disclosure pertains that other modified examples based on the technical idea of the disclosure can be embodied in addition to the embodiments disclosed herein.

1. A terminal in a wireless communication system, the terminal comprising:
a transceiver; and
a controller for controlling the transceiver;
wherein the controller is configured to:
receive, from a location management function (LMF) entity, a first message including a plurality of accuracy values corresponding to a plurality of quality of service (QOS) levels, for requesting measurement of signals for positioning, and
transmit, to the LMF entity, a second message including a measurement result corresponding to a certain accuracy value among the plurality of accuracy values and an indicator for the certain accuracy value corresponding to the measurement result.

2. The terminal of claim 1, wherein the plurality of accuracy values comprises a first value and a second value, and
wherein the QoS level of the first value is higher than the QoS level of the second value.

3. The terminal of claim 2, wherein the controller is configured to:
perform the measurement for the positioning,
identify whether the performed measurement result satisfies the QoS level corresponding to the first value, and
control the transceiver to transmit the second message including the measurement result and the indicator for the first value in case that the measurement result satisfies the QoS level corresponding to the first value.

4. The terminal of claim 2, wherein the controller is configured to:
perform the measurement for the positioning,
identify whether the performed measurement result satisfies the QoS level corresponding to the first value,
identify whether the performed measurement result satisfies the QoS level corresponding to the second value in case that the measurement result does not satisfy the QoS level corresponding to the first value, and
control the transceiver to transmit the second message including the measurement result and the indicator for the second value in case that the measurement result satisfies the QoS level corresponding to the second value.

5. The terminal of claim 2, wherein the controller is configured to:
perform the measurement in accordance with the first value during a period of a first response time corresponding to the first value in case that the first message further includes a plural pieces of response time information corresponding to the plurality of accuracy values,
perform the measurement in accordance with the second value during a period of a second response time corresponding to the second value in case that the measurement in accordance with the first value has not been completed or has failed before expiration of the first response time, and
control the transceiver to transmit the second message including error information to the LMF entity in case that the measurement in accordance with the second value has not been completed or has failed before expiration of the second response time.

6. A location management function (LMF) entity in a wireless communication system, the LMF entity comprising:
a transceiver; and
a controller for controlling the transceiver,
wherein the controller is configured to:
transmit, to a terminal, a first message including a plurality of accuracy values corresponding to a plurality of quality of service (QOS) levels, for requesting measurement of signals for positioning,
receive, from the terminal, a second message including a measurement result corresponding to a certain accuracy value among the plurality of accuracy values and an indicator for the certain accuracy value corresponding to the measurement result, and
transmit, to a location services (LCS) client having requested a service for the positioning, a third message including the measurement result and the indicator for the certain accuracy value based on the received second message.

7. The LMF entity of claim 6, wherein the plurality of accuracy values comprises a first value and a second value, and
wherein the QoS level of the first value is higher than the QoS level of the second value.

8. The LMF entity of claim 7, wherein in case that the measurement for the positioning is performed by the terminal, it is identified whether the performed measurement result satisfies the QoS level corresponding to the first value, and in case that the measurement result satisfies the QoS level corresponding to the first value, the second message includes the measurement result and the indicator for the first value.

9. The LMF entity of claim 7, wherein in case that the measurement for the positioning is performed by the terminal, it is identified whether the performed measurement result satisfies the QoS level corresponding to the first value, and in case that the measurement result does not satisfy the QoS level corresponding to the first value, it is identified whether the performed measurement result satisfies the QoS level corresponding to the second value, and in case that the measurement result satisfies the QoS level corresponding to the second value, the second message includes the measurement result and the indicator for the second value.

10. The LMF entity of claim 7, wherein the first message further comprises a plural pieces of response time information corresponding to the plurality of accuracy values, and
wherein the controller is configured to:
perform, by the terminal, the measurement in accordance with the first value during a period of a first response time corresponding to the first value,
perform, by the terminal, the measurement in accordance with the second value during a period of a second response time corresponding to the second value in case that the measurement in accordance with the first value has not been completed or has failed before expiration of the first response time, and
control the transceiver to receive a fourth message including error information from the terminal in case that the measurement in accordance with the second value has not been completed or has failed before expiration of the second response time.

11. A control method of a terminal in a wireless communication system, the control method comprising:
receiving, from a location management function (LMF) entity, a first message including a plurality of accuracy values corresponding to a plurality of quality of service (QOS) levels, for requesting measurement of signals for positioning; and
transmitting, to the LMF entity, a second message including a measurement result corresponding to a certain accuracy value among the plurality of accuracy values and an indicator for the certain accuracy value corresponding to the measurement result.

12. The method of claim 11, wherein the plurality of accuracy values comprises a first value and a second value, and
wherein the QoS level of the first value is higher than the QoS level of the second value.

13. The method of claim 12, wherein transmitting the second message further comprises:
performing the measurement for the positioning;
identifying whether the performed measurement result satisfies the QoS level corresponding to the first value;
transmitting the message including the measurement result and the indicator for the first value in case that the measurement result satisfies the QoS level corresponding to the first value;
identifying whether the performed measurement result satisfies the QoS level corresponding to the second value in case that the measurement result does not satisfy the QoS level corresponding to the first value; and
transmitting the message including the measurement result and the indicator for the second value in case that the measurement result satisfies the QoS level corresponding to the second value.

14. The method of claim 12, further comprising:
performing the measurement in accordance with the first value during a period of a first response time corresponding to the first value in case that the first message further includes a plural pieces of response time information corresponding to the plurality of accuracy values;
performing the measurement in accordance with the second value during a period of a second response time corresponding to the second value in case that the measurement in accordance with the first value has not been completed or has failed before expiration of the first response time; and
transmitting the second message including error information to the LMF entity in case that the measurement in accordance with the second value has not been completed or has failed before expiration of the second response time.

15. A control method of a location management function (LMF) entity in a wireless communication system, the method comprising:
transmitting, to a terminal, a first message including a plurality of accuracy values corresponding to a plurality of quality of service (QOS) levels, for requesting measurement of signals for positioning;
receiving, from the terminal, a second message including a measurement result corresponding to a certain accuracy value among the plurality of accuracy values and an indicator for the certain accuracy value corresponding to the measurement result; and
transmitting, to a location services (LCS) client having requested a service for the positioning, a third message including the measurement result and the indicator for the certain accuracy value based on the received second message,
wherein the plurality of accuracy values include a first value and a second value, and
wherein the QoS level of the first value is higher than the QoS level of the second value.
